(19) United States
(12) Patent Application Publication
(10) Pub. No.: US 2024/0413717 A1
(43) Pub. Date: Dec. 12, 2024

(54) MOTOR CORE MANUFACTURING METHOD AND PUSH-OUT DEVICE

(71) Applicant: NHK SPRING CO., LTD., Yokohama-shi, Kanagawa (JP)

(72) Inventors: Shuji ANDO, Yokohama-shi, Kanagawa (JP); Yuichiro JIN, Yokohama-shi, Kanagawa (JP)

(21) Appl. No.: 18/704,130

(22) PCT Filed: Oct. 31, 2022
(86) PCT No.: PCT/JP2022/040842

§ 371 Date: Apr. 24, 2024

(30) Foreign Application Priority Data
Nov. 26, 2021 (JP) 2021-192403

(51) Int. Cl. H02K 15/02; B23P 19/10

(52) U.S. Cl. CPC H02K 15/02; B23P 19/10

(57) ABSTRACT

A manufacturing method for a motor core that makes a laminated annular iron core involving an upper and a lower jigs, arranges the laminated annular iron core with respect to the push-out jig and a loading jig so as to escape tip ends of positioning pins in place of the upper jig, while applying load onto the push-out jig using the loading jig, pushes out the laminated annular iron core with respect to the positioning pins.

### FIELD OF THE INVENTION

The present invention relates to a manufacturing method of a motor core of an electric motor and a push-out device.

### BACKGROUND OF THE INVENTION

As a conventional manufacturing method of a motor core, there is a manufacturing method of a laminated iron core for a motor for driving a vehicle disclosed in Patent document 1, for example.

The manufacturing method laminates annular iron core pieces 107 on a lower plate 103 of an alignment jig having a plurality of guide pins 101 (positioning pins) in a circumferential direction, the annular iron core piece in which arc-shaped iron core pieces 105 are arranged annularly as illustrated in FIG. 14.

The laminating is performed in a state that the guide pins 101 are inserted into guide holes (positioning holes) 109, to align and hold the annular iron pieces 107.

The annular iron core pieces 107 aligned and held in a laminated state are welded together on inner peripheral portions or outer peripheral portions. After the welding, the lower plate 103 is removed from the annular iron core pieces 107 in the laminated state such that the guide pins 101 are pulled out from the guide holes 109.

In this way, it obtains a rotor core in which the annular iron core pieces 107 are laminated and welded.

The annular iron core pieces 107 in the laminated state are, however, shrunk by the welding in a radial direction, so that biting may be caused between the guide pins 101 and the guide holes 109. In this case, the annular iron core pieces 107 may be deformed by forcibly pulled from the guide pins 101.

In addition, the annular iron core piece 107 may be a single annular shape that is not a combination of the arc-shaped iron core pieces. The single-type annular iron core piece may have a positioning hole at a center thereof. Welding is performed to the laminated annular iron core pieces laminated so that the positioning holes are fitted to a positioning shaft. With this, the annular iron core pieces in the laminated state are shrunk by the welding in the radial direction to cause a problem similar to the above.

Further, in a stator core, biting after welding may be caused between positioning holes or a positioning hole and positioning pins or a positioning shaft to cause a problem similar to the above.

PATENT LITERATURE 1: JP6469355B

### SUMMARY OF THE INVENTION

A problem to be solved is that biting is caused between laminated and welded annular iron core pieces and positioning pins or a positioning shaft and the annular iron core pieces may be deformed by forcibly pulled out from the positioning pins or the positioning shaft.

The present invention provides a manufacturing method of a motor core that detaches a plurality of positioning pins in a circumferential direction or a positioning shaft at a center from a laminated annular iron core to obtain a motor core, the laminated annular iron core in which a plurality of annular iron core pieces are laminated in a state of fitted to the positioning pins or the positioning shaft, and welded together on inner peripheries or outer peripheries. The manufacturing method of a motor core fixes the positioning pins or the positioning shaft fitted to the laminated annular iron core in a laminating direction of the laminated annular iron core, arranges a push-out jig on one side of the laminated annular iron core in the laminating direction and arranges a loading jig on the other side of the laminated annular iron core in the laminating direction, advances the push-out jig while applying load onto the push-out jig using the loading jig, thereby pushing out the laminated annular iron core with respect to the positioning pins or the positioning shaft according to pushing force of the push-out jig against the load.

The present invention provides a manufacturing method of a motor core that detaches a plurality of positioning pins in a circumferential direction or a positioning shaft at a center from laminated annular iron core to obtain a motor core, the laminated annular iron core in which a plurality of annular iron core pieces are in a state of fitted to the positioning pins or the positioning shaft, laminated on a lower jig having the positioning pins or the positioning shaft and welded together on inner peripheries or outer peripheries. The manufacturing method fixes the positioning pins or the positioning shaft fitted to the laminated annular iron core in a laminating direction of the laminated annular iron core through the lower jig on which the laminated annular iron core pieces is stacked, arranges a push-out jig on a lower side of the laminated annular iron core in the laminating direction and arranges a loading jig on an upper side of the laminated annular iron core in the laminating direction, advances a push-out pin provided on the push-out jig through a lower-jig-escaping portion provided on the lower jig while applying load onto the push-out jig using the loading jig, thereby pushing out the laminated annular iron core with respect to the positioning pins or the positioning shaft according to pushing force of the push-out pin against the load.

Further, the present invention provides a push-out jig having a push-out pin movably forward and backward to push out the laminated annular iron core with respect to the positioning pins or the positioning shaft, and a loading jig to apply the load while escaping the tip ends of the positioning pins or the tip end of the positioning shaft.

The manufacturing method of a motor core of the present invention, even if the laminated annular iron core pieces bites the positioning pins or the positioning shaft, pushes out the laminated annular iron core pieces from the positioning pins or the positioning shaft while preventing the laminated annular iron core pieces from being deformed.

The push-out device for a laminated annular iron core of the present invention realizes the manufacturing method of a motor core and, even if the laminated annular iron core pieces bite the positioning pins or the positioning shaft, pushes out the laminated annular iron core pieces from the positioning pins or the positioning shaft while preventing the laminated annular iron core pieces from being deformed.

### BRIEF DESCRIPTION OF THE DRAWINGS

FIG. 1 is a schematic sectional view illustrating an overview of a push-out device for a laminated annular iron core according to an embodiment 1 of the present invention;

FIG. 2 is a schematic sectional view of an upper-jig-detaching step according to the embodiment 1;

FIG. 3 is a schematic sectional view of a load-applying step according to the embodiment 1;

FIG. 4 is a schematic sectional view of a pushing-out step according to the embodiment 1;

FIG. 5 is a schematic sectional view illustrating a pushing-out position of the laminated annular iron core at the pushing-out step of FIG. 4;

FIG. 6 is a schematic sectional view illustrating conveyance at a conveying step according to the embodiment 1;

FIG. 7 is a schematic sectional view illustrating return of push-out pins at a returning step according to the embodiment 1;

FIG. 8 is an enlarged schematic sectional view illustrating a modification of a positioning pin;

FIG. 9 is an enlarged schematic sectional view illustrating a modification of a push-out pin;

FIG. 10 is a schematic sectional view illustrating another modification of a push-out pin;

FIG. 11 is a schematic sectional view illustrating a modification of a locking part;

FIG. 12 is a schematic plan view of a laminated annular iron core for a rotor core according to an embodiment 2 of the present invention;

FIG. 13 is a schematic plan view of a laminated annular iron core for a stator core according to a modification; and

FIG. 14 is a perspective view illustrating a laminated state of annular iron core pieces according to the related art.

### EMBODIMENT FOR CARRYING OUT THE INVENTION

The present invention achieves the object capable of, even if biting is caused between laminated annular iron core pieces and positioning pins or a positioning shaft after welding, pushing out the laminated annular iron core pieces from the positioning pins or the positioning shaft while preventing or suppressing the laminated annular iron core pieces from being deformed by pressing a laminated and welded annular iron core from both sides in a laminating direction to push out the laminated and welded annular iron core from the positioning pins or the positioning shaft at a center.

A manufacturing method of a motor core of the present invention detaches a plurality of positioning pins (3) in a circumferential direction or a positioning shaft (45, 49) at a center from a laminated annular iron core (5) to obtain a motor core (2), the laminated annular iron core in which a plurality of annular iron core pieces (4) are laminated in a state of fitted to positioning pins (3) and a positioning shaft (45, 49) and welded together on inner peripheries or outer peripheries.

In particular, the positioning pins (3) or the positioning shaft (45, 49) fitted to the laminated annular iron core (5) are fixed in a laminating direction of the laminated annular iron core (5), a push-out jig (19) is arranged on one side of the laminated annular iron core (5) in the laminating direction and a loading jig (21) is arranged on the other side of the laminated annular iron core (5) in the laminating direction, load is applied onto the push-out jig (19) using the loading jig (21) and the laminated annular iron core (5) is pushed out with respect to the positioning pins (3) or the positioning shaft (45, 49) according to pushing force of the push-out jig (19) based on advance of the push-out jig (19) against the load.

The positioning pins (3) or the positioning shaft (45, 49) may be provided on a lower jig (7). In this case, the laminated annular iron core (5) is stacked and mutually welded on the lower jig (7) and fixing the positioning pins (3) or the positioning shaft (45, 49) is performed through the lower jig (7).

An upper jig (9) may be arranged above the laminated annular iron core (5) in the laminating direction to hold the laminated annular iron core between the lower jig (7) and the upper jig (9) in the state of fitted to the positioning pins (3) or the positioning shaft (45, 49), and tip ends of the positioning pins (3) or a tip end of the positioning shaft (45, 49) projecting from the laminated annular iron core (5) may be fitted to upper-jig-positioning apertures or an upper-jig-positioning aperture (13) provided on the upper jig (9), so that the laminated annular iron core (5) involves the lower jig (7) and the upper jig (9).

In this case, the loading jig (21) is arranged in place of the upper jig (9) so as to escape the tip ends of the positioning pins (3) or the tip end of the positioning shaft (45, 49).

An intermediate jig (15) may be interposed between the laminated annular iron core (5) and the lower jig (7), and the pushing force of the push-out pin (23) may be applied onto the intermediate jig (15).

The pushing-out of the laminated annular iron core (5) may be conducted until only the tip ends of the positioning pins (3) are positioned within the laminated annular iron core (5).

The tip ends or the tip end of the positioning pins (3) or the positioning shaft (45, 49) may be provided with tapered portions or a tapered portion (37).

After pushing out the laminated annular iron core (5), the loading jig (21) may be retracted, the laminated annular iron core (5) may be lifted and released from the positioning pins (3) and be conveyed with transverse movement.

A push-out device (1) for the laminated annular iron core (5) used in the manufacturing method of the motor core (2) of the present invention, comprises the push-out jig (19) and the loading jig (21). The push-out jig (19) has a push-out pin (23) movably forward and backward to push out the laminated annular iron core (5) with respect to the positioning pins (3). The loading jig (21) applies the load while escaping the tip ends of the positioning pins (3).

The loading jig (21) may be provided with a loading-jig-escaping portion (25) to escape the positioning pins (3) or the positioning shaft (45, 49).

The push-out device (1) may have a locking part (27) releasably fixing the lower jig (7) to the push-out jig (19), the lower jig arranged relatively to the push-out jig (19).

The locking part (27) may have inclined faces (29) or curved faces (41) provided on side edge portions of the lower jig (7), and a movable portion (31) having inclined faces (33) or curved faces (43) provided so as to face and selectively contact the inclined faces (29) or the curved faces (41) to conduct the fixing of the lower jig (7).

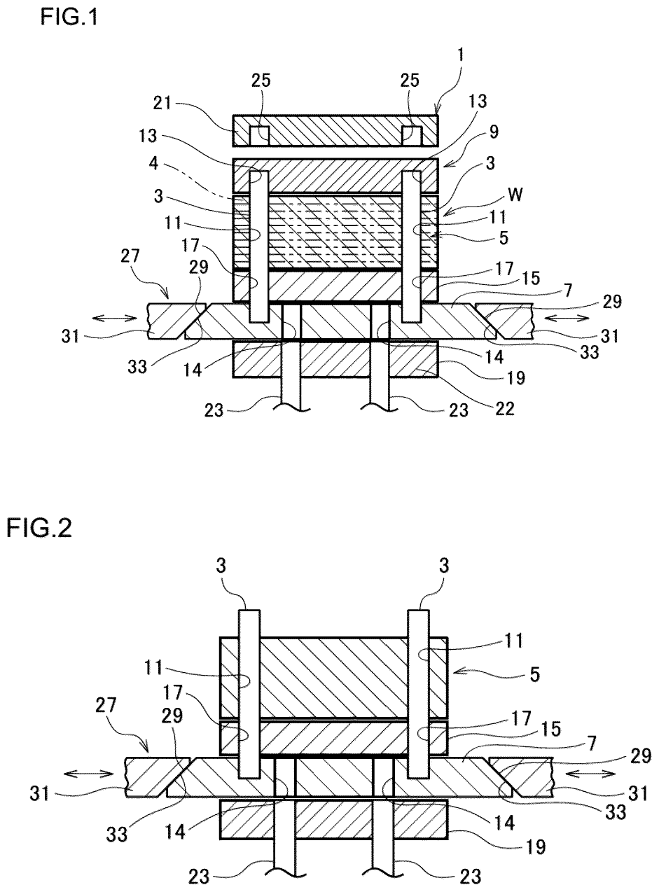

FIG. 1 is a schematic sectional view illustrating an overview of a push-out device for a laminated annular iron core according to the embodiment.

A push-out device 1 for a laminated annular iron core is used for a manufacturing method of a motor core and is, for example, incorporated in a manufacturing line. The motor core is a rotor core or a stater core. According to the embodiment, the push-out device 1 push out welded annular iron core pieces 4 in a laminated state, i.e. a laminated annular iron core 5 relative to positioning pins 3 of an iron core W including jigs, to obtain the motor core.

It should be noted that formation of the iron core W including the jigs is performed similarly to the related art of FIG. 14. The annular iron core piece 4 should be, however, any one of an annular iron core piece in which arc-shaped iron core pieces are arranged annularly or a single annular iron core piece.

The iron core W including the jigs is one in which a plurality of the annular iron core pieces 4 are laminated between a lower jig 7 and an upper jig 9 and welded together on inner peripheries or outer peripheries. Namely, the laminated annular iron core 5 involving the upper and the lower jig 9 and 7 forms the iron core W including the jigs. Up and down are those in a laminating direction.

The lower jig 7 has positioning pins 3. A plurality of the positioning pins 3 are provided at regular intervals in a circumferential direction, and are inserted into iron-core-positioning holes 11 of the laminated annular iron core 5 stacked on the lower jig 7. With this insertion, the annular iron core pieces 14 of the laminated annular iron core 5 are fitted to the positioning pins 3 to be aligned and held on the lower jig 7 of an alignment jig. It should be noted that only the positioning pins 3 may hold the annular iron core pieces 14 of the laminated annular iron core 5 with omission of the lower jig 7.

The positioning pins 3 pass through the laminated annular iron core 5 in the laminating direction, tip ends of which are projected from the laminated annular iron core 5. Upper-jig-positioning holes 13 provided on the upper jig 9 are fitted to the tip ends of the positioning pins 3.

According to the embodiment, the iron core W including the jigs is provided with a lower-jig-escaping portion 14 on the lower jig 7. The lower-jig-escaping portion 14 is formed by through-holes in the laminating direction of the laminated annular iron core 5. It should be noted that the lower-jig-escaping portion 14 may include an outer shape escaping the positioning pins 3, for example, a configuration having recessed portions in a direction intersecting the laminating direction on an outer periphery to escape the positioning pins 3 instead of the hole shapes escaping the positioning pins 3.

Further, the iron core W including the jigs is provided with an intermediate jig 15. The intermediate jig 15 is interposed between the laminated annular iron core 5 and the lower jig 7. The intermediate jig 15 prevents or suppresses the lower jig 7 from being affected by welding at the time of the welding.

The intermediate jig 15 of the present embodiment is formed into a flat plate shape and supports the laminated annular iron core 5 on the lower jig 7 side. The intermediate jig 15 has an intermediate-jig-escaping portion 17. The intermediate-jig-escaping portion 17 is holes passing through the intermediate jig 15 in the laminating direction and passes the positioning pins 3 therethrough.

It should be noted that the intermediate-jig-escaping portion 17 may include an outer shape escaping the positioning pins 3, for example, a configuration having recessed portions in a direction intersecting the laminating direction on an outer periphery to escape the positioning pins 3 instead of the hole shapes passing the positioning pins 3. Further, the intermediate jig 15 may be omitted.

The push-out device 1 is provided with a push-out jig 19, a loading jig 21, and a locking part 27.

The push-out jig 19 is to push out the laminated annular iron core 5 with respect to the positioning pins 3. The push-out jig 19 applies pushing force against load applied by the loading jig 21 onto the laminated annular iron core 5.

The push-out jig 19 is provided with a body portion 22 and push-out pins 23. The body portion 23 is formed into a plate shape corresponding to the lower jig 7 and the lower jig 7 is put on the body portion. It should be noted that the push-out jig 19 may be configured that the body portion 23 may move to apply the pushing force with no push-out pin 23. In this case, only the positioning pins 3 should hold the annular iron core pieces 4 of the laminated annular iron core 5 with omission of the lower jig 7 and the push-out jig should be shaped so as not to interfere with the positioning pins 3.

The push-out pins 23 are portions configured movably forward and backward in the laminating direction to apply the pushing force onto the laminated annular iron core 5. According to the embodiment, a plurality of the push-out pins 23 are provided at regular intervals in the circumferential direction. The number of the push-out pins 23 is not limited particularly, but it may be less than the number of the positioning pins 3. For example, eight push-out pins 23 are evenly arranged relative to sixteen positioning pins 3.

The push-out pins 23 are arranged on an imaginary circle on an inner peripheral side relative to an imaginary circle on which the positioning pins 3 are arranged. The push-out pin 23 may be, however, arranged on the concentric circle of the positioning pins 3 or an imaginary circle on an outer peripheral side relative to the imaginary circle on which the positioning pins 3 are arranged.

The push-out pins 23 are configured so as to be upward and downward driven by a servo motor or the like that is not illustrated and arranged on the push-out device 1. For the servo motor or the like for the upward and downward driving, driving control is performed by a controller to control a pushing-out amount of the push-out pins 23.

The pushing force of the push-out pins 23 against the load should be in a range capable of pushing out the laminated annular iron core 5 while preventing the annular iron core pieces from being peeled off. The push-out pin 23 should apply the pushing force and its thickness and shape are freely implemented.

The loading jig 21 is arranged in place of the upper jig 9 of the iron core W including the jigs when pushing out the laminated annular iron core 5. The loading jig 21 applies the load onto the laminated annular iron core 5 while escaping the tip ends of the positioning pins 3.

The applying of the load using the loading jig 21 is performed by a movable portion of the push-out device 1 not illustrated. On the movable portion, the loading jig 21 is supported by, for example, a coil spring or the like. The movable portion upward and downward drives the loading jig 21 through the coil spring using an actuator such as an electric motor, a hydraulic cylinder or an air cylinder. The loading jig 21 may be, however, configured to be directly driven by the actuator. The loading jig 21 is, therefore, configured so as to be movable according to control of the movable portion with respect to the iron core W including the jigs that is set on the push-out jig 19.

The load according to the actuator is set smaller than the pushing force of the push-out pins 23. The load according to the actuator is controlled so as to be kept until the pushing-out of the laminated annular iron core 5 is completed.

The loading jig 21 of the present embodiment is provided with a loading-jig-escaping portion 25 to escape the tip ends of the positioning pins 3. The loading-jig-escaping portion 25 may however, include an outer shape escaping the tip ends of the positioning pins 3, for example, a configuration having recessed portions in a direction intersecting a loading direction on an outer periphery to escape the tip ends of the positioning pins 3 instead of the hole shapes escaping the tip ends of the positioning pins 3. The loading direction is the laminating direction of the laminated annular iron core 5.

The loading jig 21 is arranged on the laminated annular iron core 5 in place of the upper jig 9 and the loading-jig-escaping portion 25 fits to the tip ends of the positioning pins 3 to be escaped. With this escaping, the loading jig 21 is entirely correctly set on the laminated annular iron core 5.

According to the embodiment, the loading-jig-escaping portion 25 is apertures not to pass through the loading jig 21 in the laminating direction. The loading-jig-escaping portion 25 should escape the tip ends of the positioning pins 3 to allow the laminated annular iron core 5 and the loading jig 21 to be contacted and may be what pass through the loading jig 21.

The locking part 27 releasably fixes the lower jig 7 arranged with respect to the push-out jig 19 when pushing out the laminated annular iron core 5. This allows the positioning pins 3 fitted to the laminated annular iron core 5 to be fixed in the laminating direction of the laminated annular iron core 5 through the lower jig 7 on which the laminated annular iron core 5 is stacked.

The locking part 27 is configured by being providing with movable members 31 with respect to side edge portions of the lower jig 7. The lower jig 7 and the movable members 31 engage with each other through inclined faces 29 and 33 in an intersecting direction relative to the laminating direction. With this, the locking part 27 fixes the lower jig 7. In addition, although the intersecting direction is a direction orthogonal to the laminating direction, the intersecting direction includes a direction slightly inclined relatively to the laminating direction (The same shall apply hereafter.).

The movable members 31 are driven by an electric motor, a hydraulic cylinder, an air cylinder, or the like not illustrated and is configured to be movable closely to or apart from the lower jig 7. The movable portions 31 is, therefore, capable of fixing the lower jig 7 according to a close drive relative to the lower jig 7 and releasing the lower jig 7 according to an apart drive relative to the lower jig.

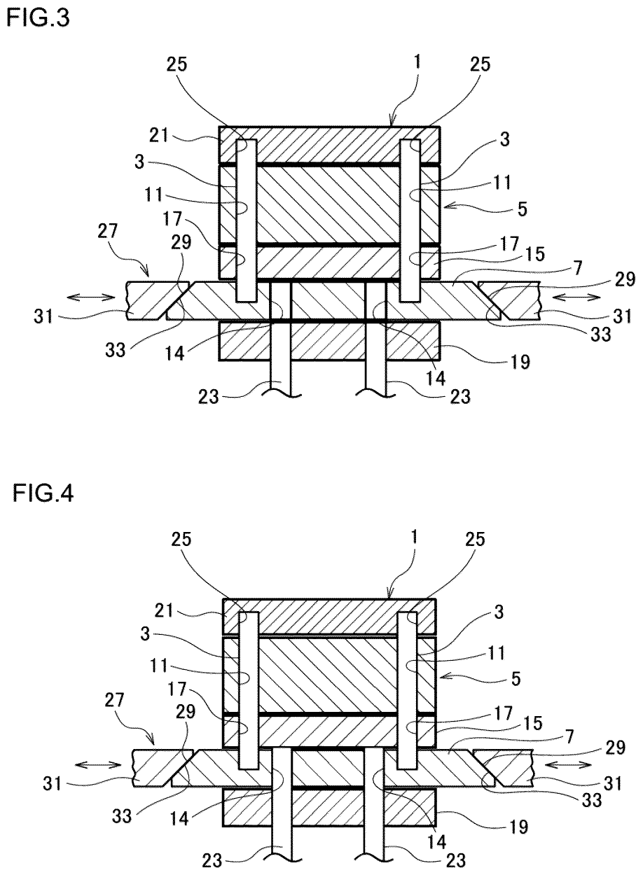

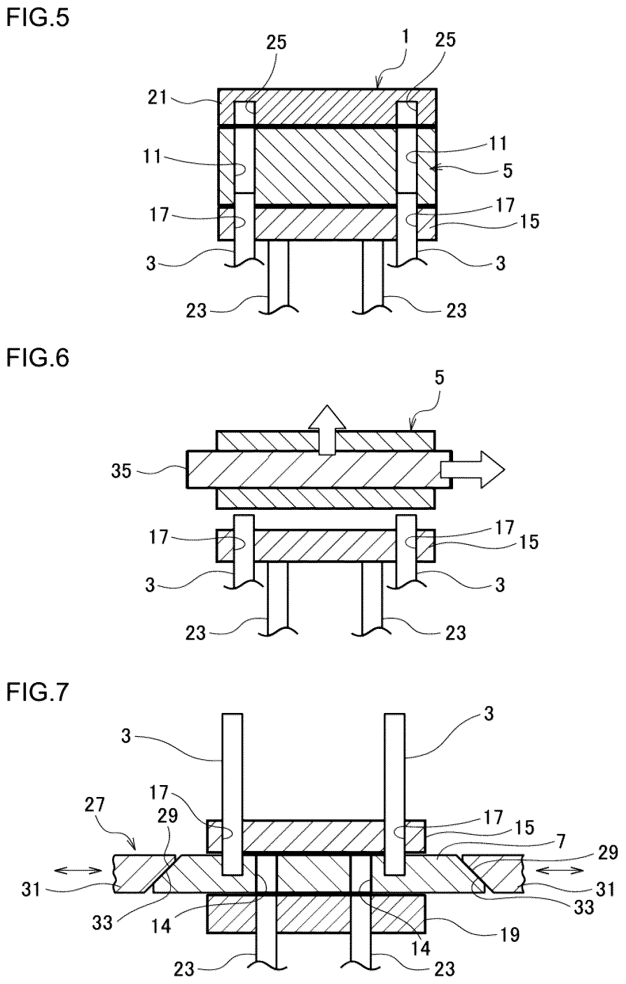

FIG. 2 is a schematic sectional view of an upper-jig-detaching step. FIG. 3 is a schematic sectional view of a load-applying step. FIG. 4 is a schematic sectional view of a pushing-out step. FIG. 5 is a schematic sectional view illustrating a pushing-out position of the laminated annular iron core at the pushing-out step. FIG. 6 is a schematic sectional view illustrating conveyance at a conveying step. FIG. 7 is a schematic sectional view illustrating return of the push-out pins at a returning step.

The manufacturing method for the motor core of the present embodiment uses the push-out device 1 to push out the laminated annular iron core 5 from the iron core W including the jigs and obtain the motor core.

In particular, the iron core W including the jigs that is arranged on the push-out device 1 is subjected to the upper-jig-detaching step, the load-applying step, the pushing-out step, the conveying step, and the returning step.

FIG. 1 is referred for arrangement of the iron core W including the jigs. In FIG. 1, although the loading jig 21 is indicated above the upper jig 9 for the explanation, the loading jig 21 is actually retracted for the arrangement of the iron core W including the jigs. In the arrangement, the laminated annular iron core 5 welded in the laminating direction is conveyed by a conveying robot to the push-out device 1 as the iron core W including the jigs involving the upper and the lower jigs 9 and 7.

The upper jig 9 may be, however, removed from the iron core W including the jigs before the conveyance. Alternatively, a welding device may have the function of the upper jig 9 to omit the upper jig 9. Thus, the iron core W including the jigs may not involve the upper jig 9.

According to the conveyance of the iron core W including the jigs, the lower jig 7 of the iron core W including the jigs is arranged on the body portion 22 of the push-out jig 19 in contact by face matching. At the time of the arrangement, the movable members 31 of the locking part 27 are retracted as well as the loading jig 21 so as not to hinder the arrangement.

The upper-jig-detaching step of FIG. 2 performs detaching of the upper jig 9.

When detaching the upper jig 9, the positioning pins 3 are fixed by the locking part 27 through the lower jig 7 in the laminating direction. Namely, the movable members 31 of the locking part 27 are operated so that the inclined faces 33 of the movable members 31 contact the inclined faces 29 of the lower jig 7.

With this contact, the fixing of the lower jig 7 is performed relatively to the push-out jig 19. Since the locking part 27 obtains tightening effect according to the contact of the inclined faces 29 and 33, the fixing of the lower jig 7 is surely performed. In this state, the upper jig 9 is detached by a robot hand or the like to reach a state of FIG. 2.

The load-applying step of FIG. 3 performs attaching of the loading jig 21.

The loading jig 21 from the retracting position is arranged on the laminated annular iron core 5 of the iron core W including the jigs by face matching. In this arrangement, the loading-jig-escaping portion 25 of the loading jig 21 are fitted to the upper ends of the positioning pins 3.

With this fitting, the loading jig 21 is arranged correctly with respect to the laminated annular iron core 5 while escaping the tip ends of the positioning pins 3. At this time, the loading jig 21 is pushed onto the laminated annular iron core 5 by a driving part which is not illustrated on the loading jig 21 side and resiliently contacts on the laminated annular iron core at a predetermined load. An area of the loading jig 21 is, therefore, expanded to a periphery of the loading-jig-escaping portion 25 and covers entirely the laminated annular iron core 5 to apply the load.

The pushing-out step of FIG. 4 performs the pushing-out of the laminated annular iron core 5.

The push-out pins 23 pass through the lower-jig-escaping portion 14 provided on the lower jig 7 according to a forward drive of the push-out pins 23 provided on the push-out jig 19. With this passing-through of the push-out pins 23, the tip ends of the push-out pins 23 contact the intermediate jig 15. Advancing the push-out pins 23 further, the pushing force is applied to the intermediate jig 15. With the applying of the pushing force, the intermediate jig 15 pushes out the laminated annular iron core 5 with respect to the positioning pins 3.

An lifting posture of the laminated annular iron core 5 based on the pushing force of the push-out pins 23 is, therefore, surely kept by presence of the intermediate jig 15, thereby surely conducting the pushing-out of the laminated annular iron core 5 from the positioning pins 3. Further, the push-out pins 23 do not directly contact the laminated annular iron core 5, to prevent contact damage of the laminated annular iron core 5 caused by the push-out pins 23.

At the time of the pushing-out according to the push-out pins 23, the lower jig 7 is fixed to the push-out jig 19 using the locking part 27. The lower jig 7, therefore, keeps a fixed position relative to the push-out jig 19 without lifting in accompany with the advancing of the push-out pins 23. At this result, the positioning pins 3 provided on the lower jig 7 is also kept similarly at the fixing position with respect to the push-out jig 19 and the laminated annular iron core 5 is surely pushed out with respect to the positioning pins 3.

The pushing-out is performed while the load is applied to the push-out jig 19 using the loading jig 21. The intermediate jig 15 is lifted together with the laminated annular iron core 5 according to the pushing force of the push-out pins 23 against the load as well as the applying of the load.

During the pushing-out, the laminated annular iron core 5 in the stacked state is held between the loading jig 21 and the intermediate jig 15. The holding is performed by force equivalent with of holding at the time of the welding in the laminating direction of the laminated annular iron core 5. The holding of the laminated annular iron core 5 at the time of the pushing-out may be performed by force different from of the holding at the time of the welding.

When the laminated annular iron core 5 is pushed out with respect to the positioning pins 3 even if biting is caused by influence of the welding therebetween, the annular iron core pieces 4 are, therefore, prevented or suppressed from being peeled off each other according to the applying of the load using the loading jig 21, thereby preventing or suppressing the annular iron core pieces 4 from being deformed.

Further, since the laminated annular iron core 5 is prevented or suppressed from posture variation with respect to the positioning pins 3 at the time of the pushing-out according to the applying of the load using the loading jig 21, the laminated annular iron core 5 is smoothly pushed out with parallel translation with respect to the positioning pins 3.

As illustrated in FIG. 5, in the pushing-out step, the pushing-out of the laminated annular iron core 5 is conducted until only the tip ends of the positioning pins 3 are positioned within the laminated annular iron core 5. The tip ends of the positioning pins 3 are, therefore, positioned at lower portions of the iron-core-positioning holes 11 of the laminated annular iron core 5. The laminated annular iron core 5 may be, however, pushed out up to a position at which the laminated annular iron core comes out from the positioning pins 3 in the pushing-out step.

The conveying step of FIG. 6 performs conveyance of the laminated annular iron core 5.

After pushing out the laminated annular iron core 5, the loading jig 21 is retracted, and the laminated annular iron core 5 is lifted and released from the push-out pins 23 and is conveyed with transverse movement. The lifting and releasing and the transverse movement are implemented by a conveying device such as a robot.

When retracting the loading jig 21, the load to the laminated annular iron core 5 is removed. In this state, the tip ends of the positioning pins 3 are positioned in the lower portions of the iron-core-positioning holes 11 to prevent or suppress positional deviation of the laminated annular iron core 5. It, therefore, prevents or suppresses conveyance error of the laminated annular iron core 5.

When conveying the laminated annular iron core 5, the laminated annular iron core is held by a conveying device such as a robot hand to be lifted with respect to the intermediate jig 15. With the lifting, the laminated annular iron core 5 is released from the positioning pins 3. Next, the laminated annular iron core is transferred to the next step with the transverse movement of the conveying device.

The returning step of FIG. 7 returns the push-out pins 23.

The pushing force of the push-out pins 23 is removed, the push-out pins 23 are retracted into the push-out jig 19, and the intermediate jig 15 is returned and contacted on the lower jig 7.

In this state, the movable members 31 of the locking part 27 are retracted to release the fixing of the lower jig 7.

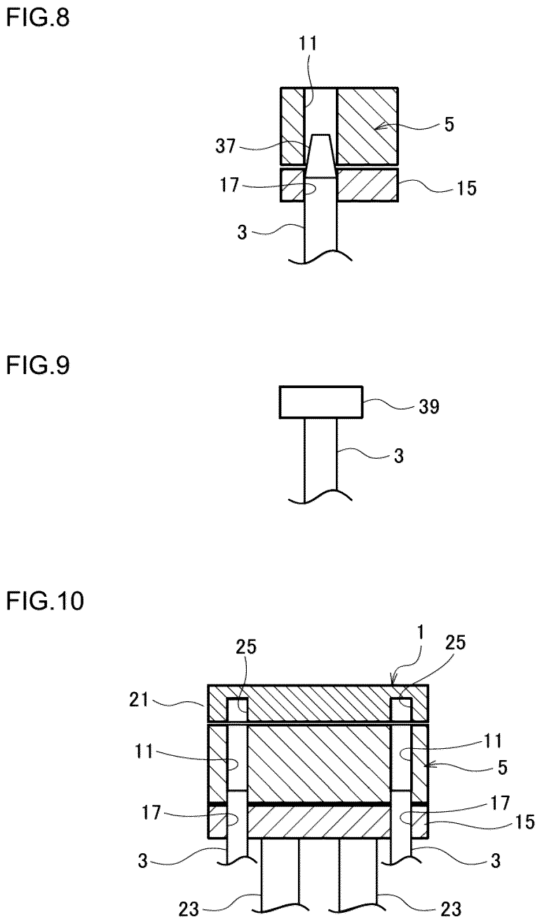

FIG. 8 is an enlarged schematic sectional view illustrating a modification of a positioning pin.

The modification of FIG. 8 is provided with a tapered portion 37 at the tip end of the positioning pin 3. The others are the same as of the embodiment 1 of FIGS. 1-7. When pushing out the laminated annular iron core 5 in the pushing-out step, only the tapered portions of the positioning pins 3 are positioned in the laminated annular iron core 5.

The positioning pins 3 makes the laminated annular iron core 5 easily released in the conveying step with the tapered portions 37 in addition to the effect of the embodiment 1. Further, it easily performs detaching and attaching of the upper jig 9 and the loading jig 21.

FIG. 9 is an enlarged schematic sectional view illustrating a modification of a push-out pin.

The modification of FIG. 9 is provided with a head 39 at the tip end of the push-out pin 23. The others are the same as of the embodiment 1 of FIGS. 1-7. The head 39 is a discrete member fixed to the push-out pin 23. The push-out pin 23 and the head 39 may be, however, formed integrally.

The push-out pin 23 is enlarged by the head 39 in contact area relative to the intermediate jig 17. Even if the push-out pin 23 directly contacts the laminated annular iron core 5, the contact area relative to the laminated annular iron core 5 is enlarged. In addition, the push-out jig 19 is shaped to have a recessed portion to accommodate the head 39 on its top face.

The head 39, therefore, contacts the intermediate jig 15, thereby stabilizing a push-out posture of the intermediate jig 15. Even if the push-out pin 23 directly contacts to push out the laminated annular iron core 5, the pushing force per unit area of the push-out pin 23 relative to the laminated annular iron core 5 is reduced. The laminated annular iron core 5 is, therefore, smoothly pushed out while preventing or suppressing the laminated annular iron core 5 from being damaged. Further, if the head 39 of the push-out pin 23 is worn away, it is easily replaced. FIG. 10 is a schematic sectional view illustrating another modification of a push-out pin.

In the modification of FIG. 10, the push-out pins 23 are enlarged in diameter to be thickened, respectively. The others are the same as of the embodiment 1 of FIGS. 1-7.

The pushing force per unit area relative to the intermediate jig 15 is, therefore, reduced to allow the laminated annular iron core 5 to be smoothly pushed out while increasing durability of the intermediate jig 15.

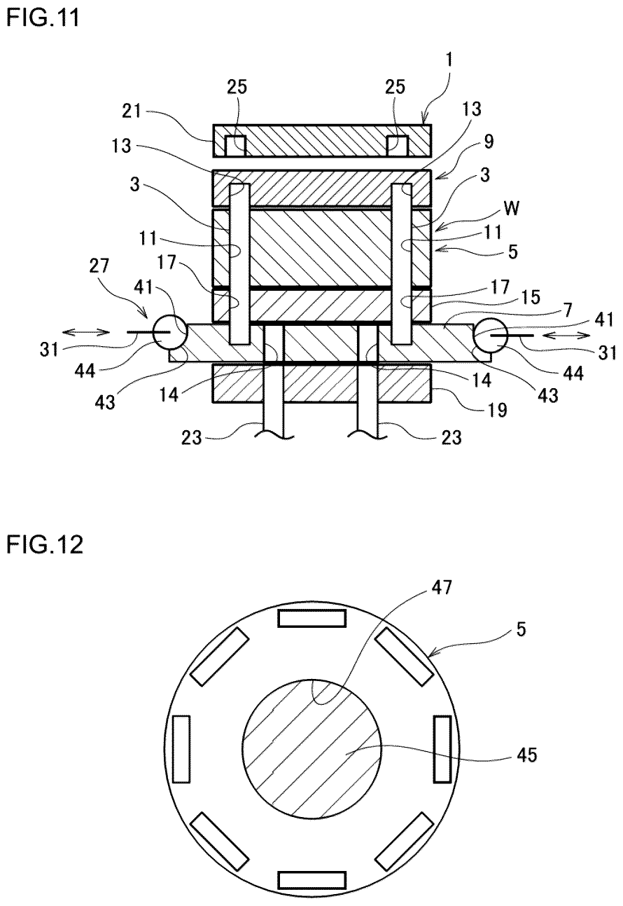

FIG. 11 is a schematic sectional view illustrating a modification of a locking part.

In the modification of FIG. 11, the locking part 27 is provided with curved faces 41 and 43 instead of the inclined faces 29 and 33. The curved faces 41 are provided on side edge portions of the lower jig 7. The curved faces 43 are provided to face and selectively contact with the curved faces 41 to fix the lower jig 7. The curved faces 43 are formed by balls 44. The balls 44 are configured to be supported by the movable members 31.

According to the contact of the curved faces 41 and 43 of the locking part 27, the fixing of lower jig 7 is, therefore, surely conducted. The locking part 27 smoothly conducts locking and lock releasing according to the contact of the curved faces 41 and 43.

FIG. 12 is a schematic plan view of a laminated annular iron core for a rotor core according to the embodiment 2 of the present invention. In addition, in the embodiment 2, components corresponding to of the embodiment 1 are represented with the same reference numerals to eliminate duplicate explanation.

As illustrated in FIG. 12, the embodiment 2 is provided with a positioning shaft 45 at a center instead of the positioning pins 3. The others are the same as of the embodiment 1. A laminated annular iron core 5 for a rotor core is formed so that a positioning hole 47 at a center is fitted to the positioning shaft 45.

In the embodiment 2, the push-out pins 23 are arranged around the positioning shaft 45 when seen in a push-out direction, thereby pushing out the laminated annular iron core 5 with respect to the positioning shaft 45 similarly to the embodiment 1.

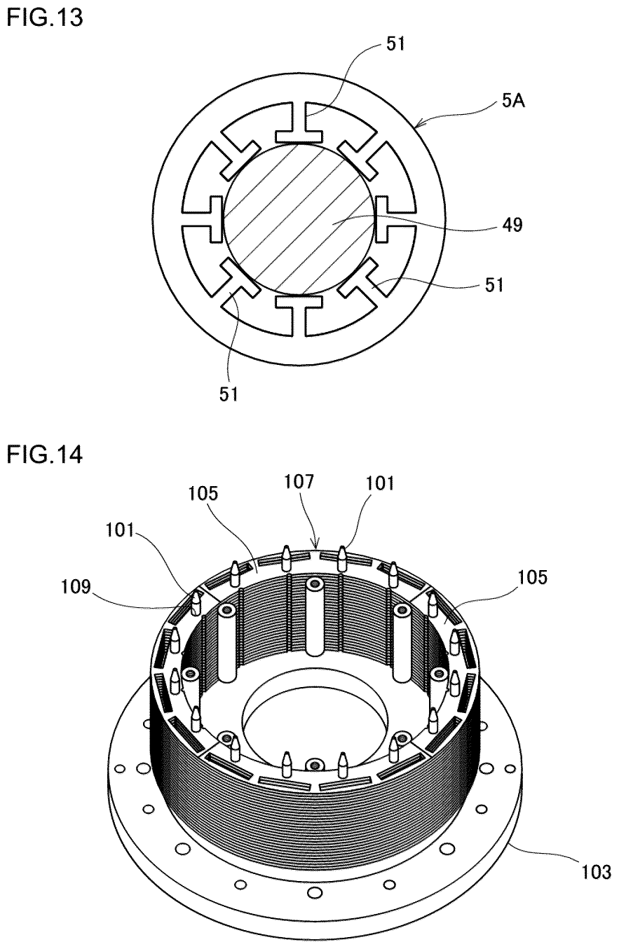

FIG. 13 is a schematic plan view of a laminated annular iron core for a stator core.

As illustrated in FIG. 13, a laminated annular iron core 5 for a stator core is formed so that teeth portions 51 are fitted to a positioning shaft 49 at a center. The others are the same as of the embodiment 2 of FIG. 12.

In this case, the push-out pins 23 are arranged around the positioning shaft 49 when seen in the push-out direction, thereby pushing out the laminated annular iron core 5 with respect to the positioning shaft 49.

1. A manufacturing method of a motor core that detaches a plurality of positioning pins in a circumferential direction or a positioning shaft at a center from a laminated annular iron core to obtain a motor core, the laminated annular iron core in which a plurality of annular iron core pieces are laminated in a state of fitted to the positioning pins or the positioning shaft, and welded together on inner peripheries or outer peripheries, comprising:
fixing the positioning pins or the positioning shaft fitted to the laminated annular iron core in a laminating direction of the laminated annular iron core;
arranging a push-out jig on one side of the laminated annular iron core in the laminating direction and arranging a loading jig on the other side of the laminated annular iron core in the laminating direction;
advancing the push-out jig while applying load onto the push-out jig using the loading jig, thereby pushing out the laminated annular iron core with respect to the positioning pins or the positioning shaft according to pushing force of the push-out jig against the load.

2. A manufacturing method of a motor core that detaches a plurality of positioning pins in a circumferential direction or a positioning shaft at a center from laminated annular iron core to obtain a motor core, the laminated annular iron core in which a plurality of annular iron core pieces are in a state of fitted to the positioning pins or the positioning shaft, laminated on a lower jig having the positioning pins or the positioning shaft and welded together on inner peripheries or outer peripheries, comprising:
fixing the positioning pins or the positioning shaft fitted to the laminated annular iron core in a laminating direction of the laminated annular iron core through the lower jig on which the laminated annular iron core pieces is stacked;
arranging a push-out jig on a lower side of the laminated annular iron core in the laminating direction and arranging a loading jig on an upper side of the laminated annular iron core in the laminating direction;
advancing a push-out pin provided on the push-out jig through a lower-jig-escaping portion provided on the lower jig while applying load onto the push-out jig using the loading jig, thereby pushing out the laminated annular iron core with respect to the positioning pins or the positioning shaft according to pushing force of the push-out pin against the load.

3. The manufacturing method of a motor core according to claim 2, wherein
an upper jig is arranged above the laminated annular iron core in the laminating direction in the state of fitted to the positioning pins or the positioning shaft to hold the laminated annular iron core between the upper jig and the lower jig, and upper-jig-positioning apertures provided on the upper jig are fitted to respective tip ends of the positioning pins or an upper-jig-positioning aperture provided on the upper jig is fitted to a tip end of the positioning shaft projecting from the laminated annular iron core, so that the laminated annular iron core involves the lower jig and the upper jig, and
the loading jig is arranged in place of the upper jig so as to escape the tip ends of the positioning pins or the tip end of the positioning shaft.

4. The manufacturing method of a motor core according to claim 2, wherein
an intermediate jig is interposed between the laminated annular iron core and the lower jig, and
the pushing force of the push-out pin is applied onto the intermediate jig.

5. The manufacturing method of a motor core according to claim 2, wherein
the pushing-out of the laminated annular iron core is conducted until only the tip ends of the positioning pins or the tip end of the positioning shaft are positioned within the laminated annular iron core.

6. The manufacturing method of a motor core according to claim 5, wherein
The tip ends of the positioning pins are provided with tapered portions. respectively or the tip end of the positioning shaft is provided with a tapered portion.

7. The manufacturing method of a motor core according to claim 2, further comprising:
retracting the loading jig;
lifting and releasing the laminated annular iron core from the positioning pins or the positioning shaft; and
conveying the laminated annular iron core with transverse movement after the pushing-out.

8. A push-out device for a laminated annular iron core used in the manufacturing method of a motor core according to claim 2, comprising:
a push-out jig having a push-out pin movably forward and backward to push out the laminated annular iron core with respect to the positioning pins or the positioning shaft; and
a loading jig to apply the load while escaping the tip ends of the positioning pins or the tip end of the positioning shaft.

9. The push-out device for a laminated annular iron core according to claim 8, wherein
the loading jig is provided with a loading-jig-escaping portion to escape the positioning pins or the positioning shaft.

10. The push-out device for a laminated annular iron core according to claim 9, further comprising:
a locking part releasably fixing the lower jig relatively to the loading jig, the lower jig arranged relatively to the push-out jig.

11. The push-out device for a laminated annular iron core according to claim 10, wherein
the locking part is provided with inclined faces or curved faces provided on side edge portions of the lower jig, and movable portions having inclined faces or curved faces, the inclined faces of the movable portions provided so as to face and selectively contact the inclined faces of the lower jig to conduct the fixing or the curved faces of the movable portions provided so as to face and selectively contact the curved faces of the lower jig to conduct the fixing.
